(19) United States
(12) Patent Application Publication
(10) Pub. No.: US 2007/0247082 A1
(43) Pub. Date: Oct. 25, 2007

(54) Discharge Lamp Operating Device

(75) Inventors: Toru Ashikaga, Saitama (JP); Toyomi Yamashita, Saitama (JP); Kazushige Hirata, Saitama (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Saken Electric Co., Ltd., Niiza-shi (JP)

(21) Appl. No.: 11/629,811

(22) PCT Filed: Feb. 1, 2006
(86) PCT No.: PCT/JP06/01663

§ 371 Date: Dec. 18, 2006

(30) Foreign Application Priority Data
Feb. 1, 2005 (JP) 2005-025462
Mar. 29, 2005 (JP) 2005-096229

(51) Int. Cl. H05B 41/26

(52) U.S. Cl. 315/277

(57) ABSTRACT

A discharge lamp lighter capable of affording appropriate lighting characteristics and removing a dispersion in current of respective discharge lamps is provided. The discharge lamp lighter includes an inverter 2 for converting direct voltage into high frequency voltage, N (N: a positive integer) pieces of discharge lamps 11 to 14 and N+1 pieces of transformers T1 to T5. Between output terminals M1 and M2 of the inverter 2, an n^{th} discharge lamp (n=1, 2, . . . , N), a primary winding of an n+1^{th} transformer and a secondary winding of an n^{th.} transformer are connected to each other in series. Further, a primary winding of a first transformer is connected to a secondary winding of an N+1^{th.} transformer in series.

### TECHNICAL FIELD

The present invention relates to a discharge lamp lighter for lighting a plurality of discharge lamps, for example, cold cathode fluorescent lamps (CCFL: Cold Cathode Fluorescent Lamps), outer electrode fluorescents, fluorescents, etc. with use of a single inverter, and particularly relates to a discharge lamp lighter for lighting a plurality of discharge lamps connected with each other in parallel.

### BACKGROUND ART

In a discharge lamp lighter, a single cold cathode fluorescent lamp is conventionally lighted with use of a single inverter. While, in a device for lighting a number of cold cathode fluorescent lamps simultaneously, for example, a device using cold cathode fluorescent lamps as backlights of a liquid crystal panel, the device becomes expensive because an increase in the number of cold cathode fluorescent lamps causes the number of inverters to be increased.

Under such a situation, there has been employed, for example, a discharge lamp lighter capable of lighting a number of cold cathode fluorescent lamps with the use of a single inverter. As such a discharge lamp lighter, Japanese Patent Application Laid-Open No. H11-238589 discloses a discharge lamp lighter where it is attempted to reduce the number of components in view of miniaturizing the lighter and also attempted to reduce a difference in optical power among discharge lamps with adoption of a circuit structure enabling respective current flowing through the discharge lamps to be equalized.

As shown in FIG. 1, this discharge lamp lighter includes an inverter part 20, a first resonant circuit 30 connected to an output side of the inverter part 20 and having an inductor CH connected to a capacitor C20 in series, a second resonant circuit 80 having at least one capacitor, a load circuit 40 consisting of a plurality of discharge lamps 41-44 and an oscillation controller 50 that changes an oscillation frequency of the inverter part 20 to light the discharge lamps in dimmer control. Between both terminals of the capacitor C20 of the first resonant circuit 30, the second resonant circuit 80 is connected to the load circuit 40 in series. The second resonant circuit 80 and the load circuit 40 are together constructed so as to equalize respective lamp current flowing through the discharge lamps. Further, an oscillation frequency of the inverter part 20 when lighting the lamps in dimmer control is set close to a natural vibration frequency of the first resonant circuit 30. With the constitution mentioned above, the discharge lamp lighter is capable of lighting the plural discharge lamps as far as low luminous flux stably and also reducing a difference in optical power among the discharge lamps.

Further, FIG. 2 is a view showing a basic constitution of a conventional discharge lamp lighter. This discharge lamp lighter comprises a direct-current power source 1, an inverter 2 and a series circuit connected between output terminals M1-M2 of the inverter 2 and having a capacitor C1, a reactor L1 and a discharge lamp 11. The inverter 2 comprises a first switching element SW1, a second switching element SW2, a capacitor C and a transformer T. In the inverter 2, the first switching element SW1 and the second switching element SW2 are turned ON/OFF alternately. Consequently, as voltage V1 of the direct-current power source 1 is impressed on the capacitor C and the transformer T intermittently, high-frequency voltage is produced on a secondary side of the transformer T. Subsequently, this high-frequency voltage is impressed on the discharge lamp 11 through ballast elements, such as the capacitor C1 and the reactor L1. In this way, lighting capability of the discharge lamp 11 can be improved.

Under a situation of lighting a plurality of discharge lamps with the use of a single inverter, dispersion in characteristics among the discharge lamps causes dispersion in lighting capability among the lamps. Additionally, there is a possibility that the dispersion in lighting capability among the discharge lamps causes respective current flowing through the discharge lamps to be varied, producing a difference in luminance among the discharge lamps. In order to solve such problems, there is provided a conventional discharge lamp lighter for lighting a plurality of discharge lights with use of a single inverter, as shown in FIG. 3. In this discharge lamp lighter, a first reactor L1 connected to a first discharge lamp 11 in series and a second reactor L2 connected to a second discharge lamp 12 in series are magnetically coupled to each other to produce a transformer T1 for balancing respective current flowing through the first discharge lamp 11 and the second discharge lamp 12.

### DISCLOSURE OF THE INVENTION

However, in the discharge lamp lighter disclosed in the above patent document, its constitution is complicated due to the presence of the first oscillation controller 50, the second resonant circuit 80, the first resonant circuit 30 and so on and additionally, the discharge lamp lighter becomes expensive. Again, in the conventional discharge lamp lighter shown in FIG. 2, it is noted that its wiring arrangement on its high-voltage side gets longer. Consequently, there is a possibility that due to influences of stray capacitance and stray inductance, the lighter's lighting efficiency is reduced and lighting characteristics is destabilized.

In the discharge lamp lighter having a constitution shown in FIG. 3 where the single inverter operates to light the plural discharge lamps, while the transformer operates to balance respective current flowing through the discharge lamps, it has been required that the transformer is provided with a large inductance. That is, if the transformer is provided with a small inductance, then resultant flux would get smaller, so that the transformer's effect to balance the current due to an interaction of magnetically-coupled windings is reduced. In the discharge lamp lighter, therefore, the transformer has a tendency to be large-sized, causing the discharge lamp lighter to be jumboized.

Therefore, an object of the present invention is to provide a discharge lamp lighter which is capable of performing appropriate lighting characteristics, eliminating a dispersion in current flowing through respective discharge lamps and miniaturizing the lighter as a whole.

In order to solve the above-mentioned problems, a main aspect of the present invention is characterized in that a discharge lamp lighter comprises an inverter for converting direct voltage into high frequency voltage; N (N: a positive integer) pieces of discharge lamps; and N+1 pieces of transformers, wherein an n^{th.} discharge lamp (n=1, 2, . . . , N), a primary winding of an n+1^{th.} transformer and a secondary winding of the n^{th.} transformer are connected in series between output terminals of the inverter, and a primary winding of a first transformer is connected to a secondary winding of the n+1^{th.} transformer in series.

Another aspect of the present invention is characterized in that in a discharge lamp lighter having an inverter for converting direct voltage into high frequency voltage and a plurality of series circuits connected to outputs of the inverter in parallel, each of the series circuits consisting of either a primary winding of a transformer or a secondary winding of the transformer and a discharge lamp, a capacitor is connected to at least either the primary winding or the secondary winding of the transformer, in parallel.

### BRIEF DESCRIPTION OF THE DRAWINGS

FIG. 1 is a view showing a constitution of a conventional discharge lamp lighter;

FIG. 2 is a view showing a basic constitution of a conventional discharge lamp lighter; and

FIG. 3 is a view showing another constitution of a conventional discharge lamp lighter.

FIG. 4 is a view showing a constitution of a discharge lamp lighter in accordance with a first embodiment of the present invention;

FIG. 5 is a view for explanation of a feature of the discharge lamp lighter in accordance with the first embodiment of the present invention;

FIG. 6 is a view showing a constitution of the discharge lamp lighter in accordance with a second embodiment of the present invention;

FIG. 7 is a view showing an equivalent circuit used in the discharge lamp lighter in accordance with the second embodiment of the present invention;

FIG. 8 is a view showing a constitution of a modification of the discharge lamp lighter in accordance with the second embodiment of the present invention;

FIG. 9 is a view showing a constitution of another modification of the discharge lamp lighter in accordance with the second embodiment of the present invention;

FIG. 10 is a view showing a constitution of the discharge lamp lighter in accordance with a third embodiment of the present invention;

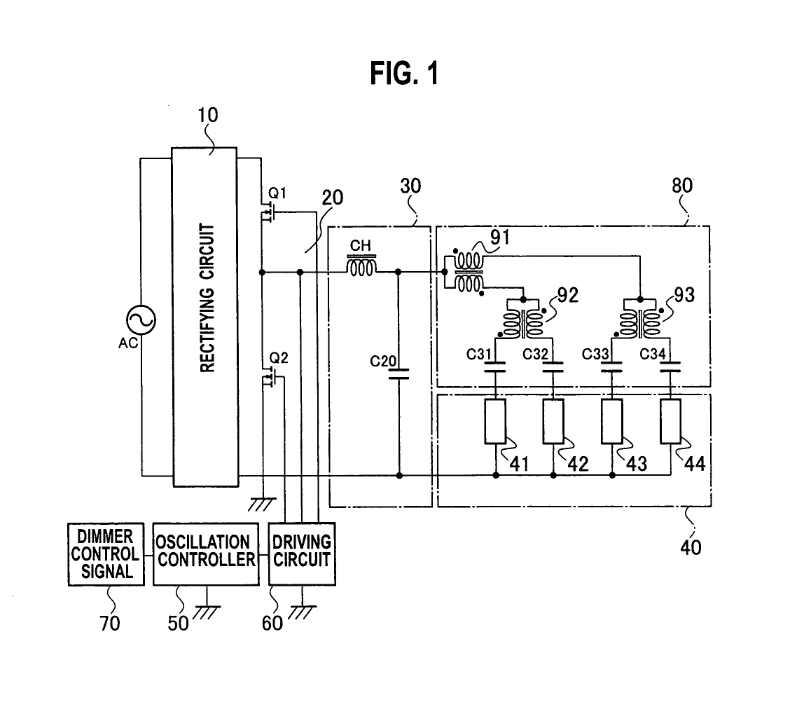

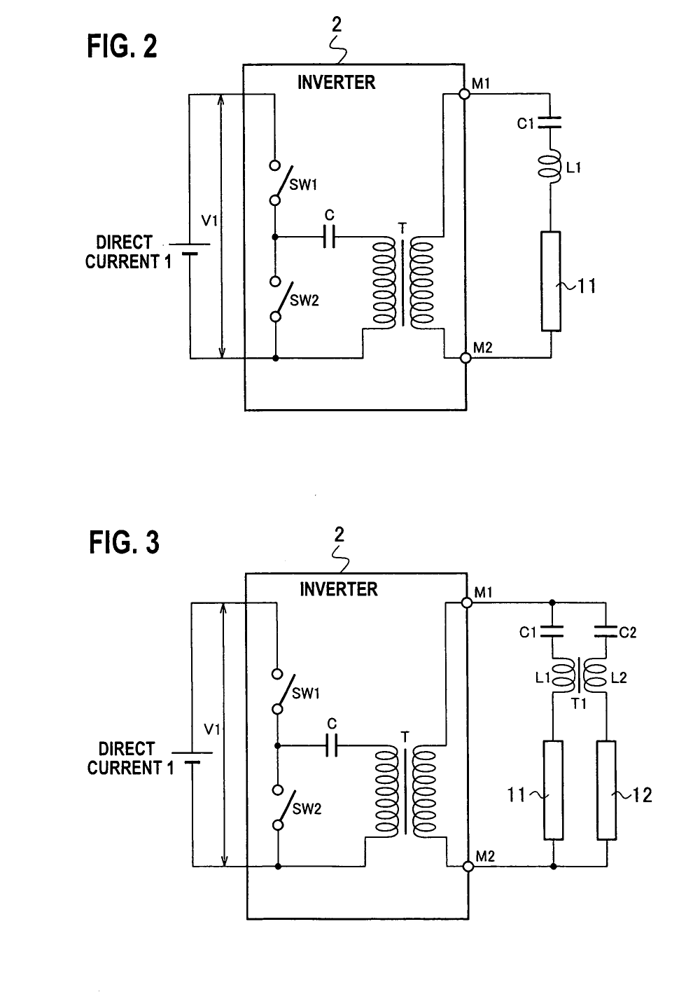

### BEST MODE FOR CARRYING OUT THE INVENTION

Embodiments of the present invention will be described in detail, with reference to drawings. Note that the following explanation is illustrated by citing an example of four (4) in the number N of discharge lamps. Nevertheless, the number N could be selected optionally.

### EMBODIMENT 1

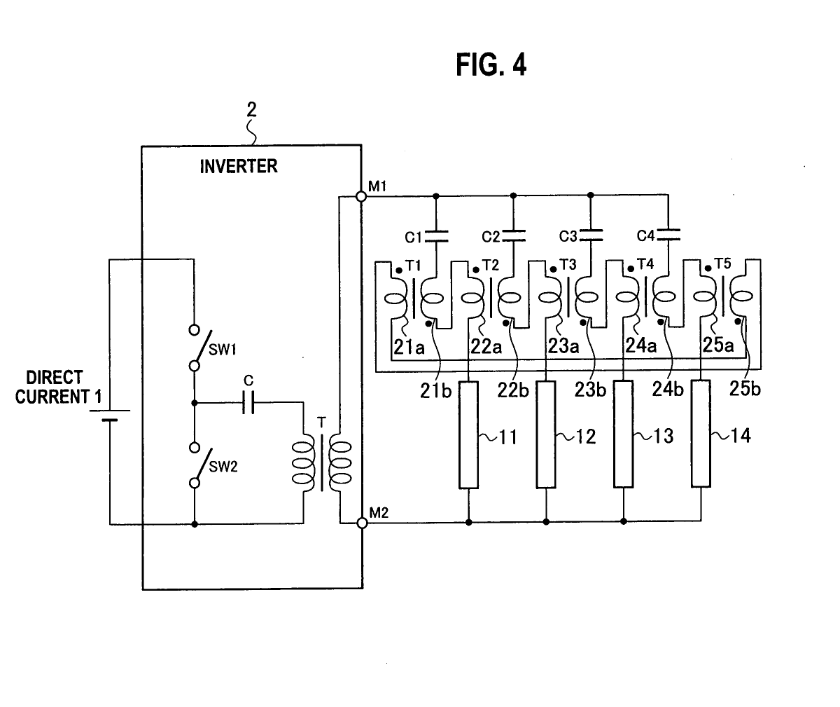

FIG. 4 is a view showing a constitution of a discharge lamp lighter in accordance with a first embodiment of the present invention. This discharge lamp lighter comprises a direct-current power source 1, an inverter 2, a first capacitor C1 to a fourth capacitor C4, a first discharge lamp 11 to a fourth discharge lamps 14 and a first transformer T1 to a fifth transformer T5. The first to fourth discharge lamps 11 to 14 are formed by e.g. cold cathode fluorescent lamps, outer electrode fluorescents, fluorescents and so on.

The direct-current power source 1 supplies direct-current voltage to the inverter 2. The inverter 2 comprises a first switching element SW1, a second switching element SW2, a capacitor C and a transformer T. The first switching element SW1 and the second switching element SW2 are connected to each other in series and connected to the direct-current power source 1 in parallel. A connection point between the first switching element SW1 and the second switching element SW2 is connected to one end of the capacitor C, while the other end of the capacitor C is connected to a primary winding of the transformer T. A secondary winding of the transformer T is connected to both an output terminal M1 on a high-voltage side of the inverter and an output terminal M2 on its low-voltage side.

In the inverter 2 constructed above, when the first switching element SW1 and the second switching element SW2 are exclusively switched ON/OFF by control signals from a not-shown control circuit, high-frequency voltage is impressed on the primary winding of the transformer T. Consequently, high-frequency high voltage inducted in the secondary winding of the transformer T is generated between the output terminal M1 and the output terminal M2.

The first to fourth capacitors C1 to C4 function as ballast elements, controlling current flowing through the first to fourth transformers T1 to T4, respectively. Respective one ends of the first to fourth capacitors C1 to C4 are connected to the output terminal M1 on the high-voltage side of the inverter 2 in common, while the other ends of the first to fourth capacitors are connected to secondary windings 21b to 24b of the first to fourth transformers T1 to T4, respectively.

The secondary winding 21b of the first transformer T1 is connected to one end of the first discharge lamp 11 through a primary winding 22a of the second transformer T2. The secondary winding 22b of the second transformer T2 is connected to one end of the second discharge lamp 12 through a primary winding 23a of the third transformer T3. The secondary winding 23b of the third transformer T3 is connected to one end of the third discharge lamp 13 through a primary winding 24a of the fourth transformer T4. The secondary winding 24b of the fourth transformer T4 is connected to one end of the fourth discharge lamp T4 through a primary winding 25a of the fifth transformer T5. Further, a first winding 21b of the first transformer T1 is connected to a secondary winding 25b of the fifth transformer T5 in series. The respective other ends of the first to fourth discharge lamps 11 to 14 are connected to the output terminal M2 on the low-voltage side of the inverter 2 in common.

Next, we describe an operation of the so-constructed discharge lamp lighter of the first embodiment. First, in each of the first to fifth transformers T1 to T5, there is established a relationship of 11 (current of the primary winding)×n1(wire turns of the primary winding)=12(current of the secondary winding)×n2(wire turns of the secondary winding).

Additionally, since the primary winding 22a of the second transformer T2 is connected to the first discharge lamp 11 in series and furthermore, the secondary winding 22b of the second transformer T2 is connected to the primary winding 23a of the third transformer T3 in series, which is connected to the second discharge lamp 12 in series, the second transformer T2 operates to balance respective current flowing through the first discharge lamp 11 and the second discharge lamps 12 so as to have the same values.

Similarly, since the primary winding 23a of the third transformer T3 is connected to the second discharge lamp 12 in series and furthermore, the secondary winding 23b of the third transformer T3 is connected to the primary winding 24a of the fourth transformer T4 in series, which is connected to the third discharge lamp 13 in series, the third transformer T3 operates to balance respective current flowing through the second discharge lamp 12 and the third discharge lamps 13 so as to have the same values.

Similarly, since the primary winding 24a of the fourth transformer T4 is connected to the third discharge lamp 13 in series and furthermore, the secondary winding 24b of the fourth transformer T4 is connected to the primary winding 25a of the fifth transformer T5 in series, which is connected to the fourth discharge lamp 14 in series, the second transformer T4 operates to balance respective current flowing through the third discharge lamp 13 and the fourth discharge lamps 14 so as to have the same values.

Again, the current flowing through the first discharge lamp 11 and the current flowing through the fourth discharge lamp 14 are balanced by the first transformer T1 and the fifth transformer T5. That is, the current flowing through the first discharge lamp 11 causes voltage in the secondary winding 21b of the first transformer T1, so that voltage is induced in the primary winding 21a of the first transformer T1 magnetically coupled to the secondary winding 21b. Also, the current flowing through the fourth discharge lamp 14 causes voltage in the primary winding 25a of the fifth transformer T5, so that voltage is induced in the secondary winding 25b of the fifth transformer T5 magnetically coupled to the primary winding 25a.

Here, if the current flowing through the first discharge lamp 11 is equal to the current flowing through the fourth discharge lamp 14, the voltage induced in the primary winding 21a of the first transformer T1 becomes equal to the voltage induced in the secondary winding 25b of the fifth transformer T5, producing no action due to their counterbalance.

While, if the current flowing through the first discharge lamp 11 is larger than the current flowing through the fourth discharge lamp 14, then the voltage induced in the primary winding 21a of the first transformer T1 becomes larger than the voltage induced in the secondary winding 25b of the fifth transformer T5, causing a flowing of current corresponding to a difference in voltage.

By this current, flux is produced in both of the first transformer T1 and the fifth transformer T5, so that the first transformer T1 acts to reduce current flowing from the secondary winding 21b to the first discharge lamp 11, while the fifth transformer T5 acts to increase current flowing from the first winding 25a to the fourth discharge lamp 14. Thus, the current flowing through the first discharge lamp 11 and the current flowing through the fourth discharge lamp 14 are balanced. Consequently, luminance of the first discharge lamp 11 becomes equal to luminance of the fourth discharge lamp 14.

With the above-mentioned operation, it is possible to equalize the respective current flowing through the first to fourth discharge lamps 11 to 14. Accordingly, a dispersion among the respective current flowing through the first to fourth discharge lamps 11 to 14 is eliminated and additionally, a power factor becomes substantial “1”. As a result, it is possible to equalize the respective luminance of the first to fourth discharge lamps 11 to 14.

Next, we explain the operations of the first to fourth discharge lamps 11 to 14 at startup. First, the inverter 2 is activated to generate high voltage between the output terminal M1 and the output terminal M2. Then, when the so-generated high voltage exceeds a predetermined starting voltage, the first to fourth discharge lamps 11 to 14 are lighted in sequence.

Now suppose that three lumps, for example, the first to third discharge lamps 11 to 13 are being lighted, while the fourth discharge lamp 14 is not lighted yet. In such a case, the first transformer T1 and the side of the secondary winding 24b of the fourth transformer T4 are brought into an opened state due to their proximity to no load, so that high voltage is produced. Consequently, the so-produced high voltage is impressed on the fourth discharge lamp 14 and immediately, it is lighted up. The same holds true for the other discharge lamps.

Thus, even if there occurs a delay of lighting in a given discharge lamp, it becomes easy to light the same discharge lamp due to raised voltage impressed on it, whereby it is possible to avoid a situation where there remains a discharge lamp being unlighted up. That is, if exceeding a generator voltage for a discharge lamp which is the easiest one of the four discharge lamps to be lighted, then it becomes possible to light all of the discharge lamps. Additionally, the secondary winding of the transformer T forming the inverter 2 is quit for low voltage, improving the reliability of the lighter.

After the first to fourth discharge lamps 11 to 14 have been all lighted, the respective current flowing through the first to fourth discharge lamps 11 to 14 are maintained at the same values in accordance with the above relational expression. If there exists a dispersion among the respective voltage of the first to fourth discharge lamps 11 to 14, respective difference voltage are impressed on the first to fifth transformers T1 to T5, so that they absorb the dispersion. In detail, varied voltage are impressed on the first to fifth transformers T1 to T5, so that constant current determined by the respective current of the primary windings of the first to fifth transformers T1 to T5 and their turn ratios flows through the first to fourth discharge lamps 11 to 14.

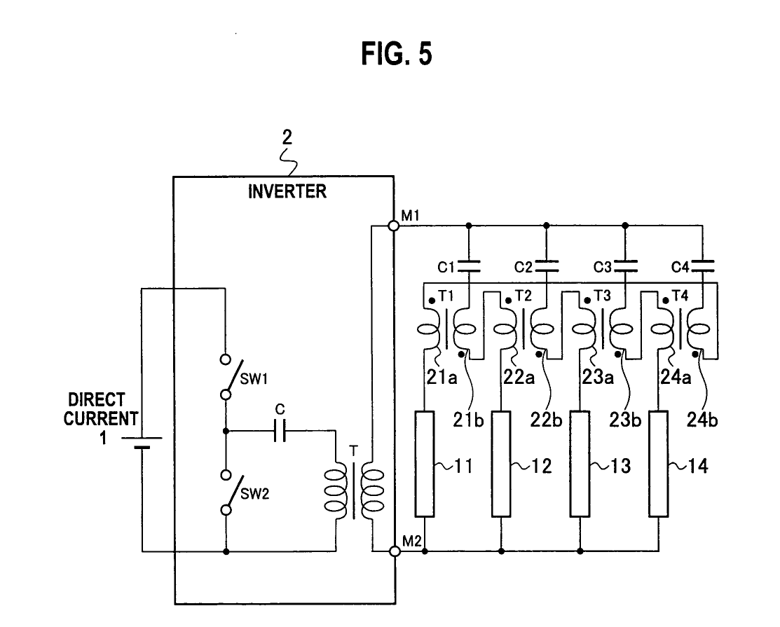

FIG. 5 shows that a view for explaining a feature of a discharge lamp lighter according to a first embodiment of the present invention. Although this discharge lamp lighter has the similar effects as the previously-mentioned discharge lamp lighter of the first embodiment, the former has the following problems.

That is, if this discharge lamp lighter is utilized as e.g. a backlight for liquid crystal panel, the first to fourth discharge lamps 11 to 14 would be arranged over a large area in dispersion. In this case, as the first to fourth transformers T1 to T4 are arranged beside the first to fourth discharge lamps 11 to 14 respectively, a wiring returning to the primary winding of the first transformer T1 from the secondary winding 24b of the fourth transformer T4 gets longer physically. Consequently, there is a possibility that due to influences of stray capacitance and stray inductance, the lighter's lighting efficiency is reduced and lighting characteristics is destabilized.

On the contrary, in the discharge lamp lighter of the first embodiment of the present invention, as the voltage generated between the primary winding 21a of the first transformer T1 and the secondary winding 25b of the fifth transformer T5 is derived from a difference between the current flowing through the first discharge lamp 11 and the current flowing through the fourth discharge lamp 14, a value of the voltage is small and the current flowing through these windings is small as well.

Thus, due to less influences of stray capacitance and stray inductance, even if a wiring between the primary winding 21a of the first transformer T1 and the secondary winding 25b of the fifth transformer T5 gets longer, there would be no occurrence of the reduction in efficiency and the destabilization in characteristics. Therefore, it would not produce any problem even if arranging the first to fifth transformers T1 to T5 on the high-voltage side of the inverter as shown in FIG. 4.

In the above-mentioned discharge lamp lighter of the first embodiment, additionally, the first to fourth capacitors C1 to C4 as ballast elements are arranged between the output terminal M1 on the high-voltage side of the inverter 2 and the secondary winding 21b of the first transformer T1 to the secondary winding 24b of the fourth transformer T4. Accordingly, the respective current flowing through the first to fourth discharge lamps 11 to 14 are restrained. Namely, it is possible to lower maximum voltage of the first to fifth transformers T1 to T5. Note that without being limited to the capacitors only, reactors and leak inductances for transformers may be used as the ballast elements.

In the discharge lamp lighter of the first embodiment of the present invention, it is not necessarily required to arrange the first to fourth capacitors C1 to C4 as the ballast elements. In case of no ballast elements, the lighting of discharge lamps would be quit for low voltage because of no impedance of such ballast elements and further, the transformer T in the inverter 2 would be also quit for reduced voltage, improving the reliability of the lighter. Thus, without preparing a ballast element with respect to each discharge lamp and also increasing respective output voltage of the transformers, it is possible to attain appropriate lighting characteristics of the lighter.

As mentioned above, according to the discharge lamp lighter of the first embodiment of the present invention, the current flowing through the first discharge lamp 11 and the current flowing through the fourth discharge lamp 14 are balanced by the first transformer T1 and the fifth transformer T5, the current flowing through the first discharge lamp 11 and the current flowing through the second discharge lamp 12 are balanced by the second transformer T2, the current flowing through the second discharge lamp 12 and the current flowing through the third discharge lamp 13 are balanced by the third transformer T3, and the current flowing through the third discharge lamp 13 and the current flowing through the fourth discharge lamp 14 are balanced by the fourth transformer T4.

Consequently, since the respective current flowing through all of the discharge lamps are balanced, it is possible to remove a dispersion of current for the discharge lamps, accomplishing the appropriate lighting characteristics.

Again, in the transformers for balancing the current flowing through four discharge lamps, there is no occurrence of high voltage in a circuit where the windings are connected with each other in parallel. Therefore, utilizing that there is no constrain in wiring in the discharge lamp lighter, the first to fifth transformers T1 to T5 are juxtaposed on the high-voltage side of the inverter 2, while a lighter's portion where a wiring between the first transformer T1 and the fifth transformer T5 on both sides of the lighter becomes longer is constructed so that the windings are connected with each other in parallel. Accordingly, it is possible to prevent a reduction in efficiency and destabilization in lighting characteristics, equalizing respective luminance of the discharge lamps.

Additionally, since respective wirings of four discharge lamps on the low-voltage side are collectively connected to the output terminal M2 on the low-voltage side of the inverter 2, it is possible to realize low-cost production, easy-assembling and stabilization in characteristics of the lighter.

Moreover, the first to fourth capacitors C1 to C4 as the ballast elements are inserted between the output terminal M1 of the high-voltage side of the inverter 2 and the secondary windings 21b to 24b of the first to fourth transformers T1 to T4, in series, respectively. Therefore, it is possible to improve a lighting performance of the lighter furthermore.

Although the discharge lamp lighter of the first embodiment of the present invention includes the first to fourth capacitors C1 to C4 as the ballast elements and the first to fifth transformers T1 to T5 arranged on the high-voltage side and the first to fourth discharge lamps 11 to 14 arranged on the low-voltage side, such an arrangement of these constituents may be reversed, that is, the first to fourth discharge lamps 11 to 14 on the high-voltage side and the first to fourth capacitors C1 to C4 as the ballast elements and the first to fifth transformers T1 to T5 on the low-voltage side.

### EMBODIMENT 2

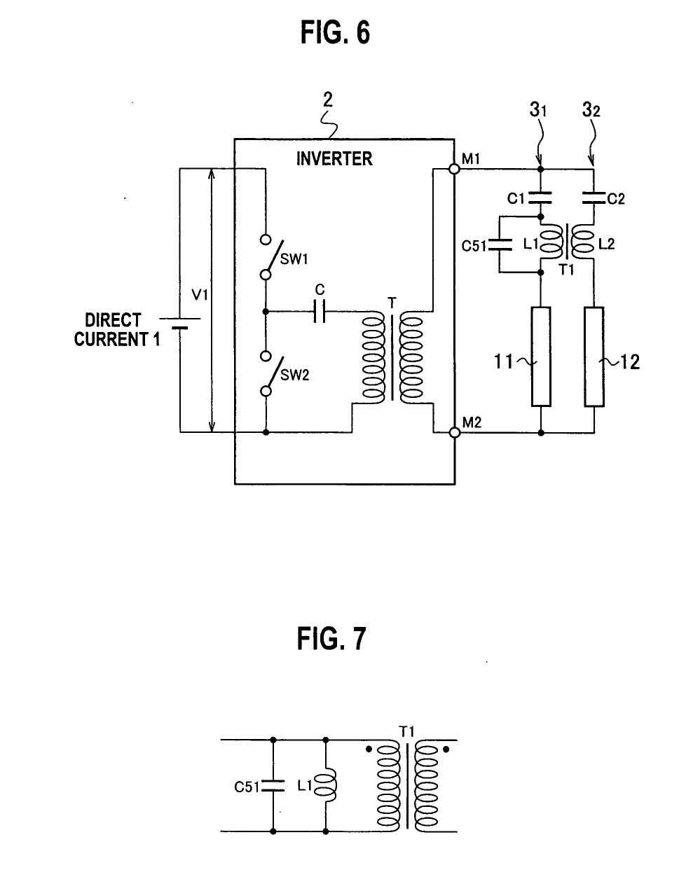

FIG. 6 is a view showing a constitution of the discharge lamp lighter in accordance with the second embodiment of the present invention. This discharge lamp lighter comprises the direct-current power source 1, the inverter 2, a first series circuit 3₁ and a second series circuit 3₂. As the constitutions and operations of the direct-current power source 1 and the inverter 2 are identical to those of the above discharge lamp lighter of the first embodiment, their descriptions are eliminated.

The first series circuit 3₁ is connected between the output outputs M1-M2 of the inverter 2 and comprises a first reactor L1 and the first discharge lamp 11 connected to each other in series. Further, the second series circuit 3₂ is connected to the first series circuit 3₁ in parallel and comprises a second reactor L2 and the second discharge lamp 12 connected to each other in series.

The first reactor L1 of the first series circuit 3₁ is formed by the primary winding (represented with “L1” below) of the first transformer T1, while the second reactor L2 of the second series circuit 3₂ is formed by the secondary winding (represented with “L2” below) of the first transformer T1. In the primary winding L1 and the secondary winding L2 of the first transformer T1, wires are wound with the same wire turns such that respective flux generated from both windings are canceled each other. Accordingly, so long as the current flowing through the primary winding L1 is the same as the current flowing through the secondary winding L2, the flux generated from the respective windings are canceled each other, so that the first transformer T1 does not work due to no flux.

While, if the current flowing through the primary winding L1 of the first transformer T1 is larger than the current flowing through the secondary winding L2, then flux is produced. This flux acts to reduce the current flowing through the primary winding L1 and increase the current flowing through the secondary winding L2. Consequently, the current flowing through the primary winding L1 and the current flowing through the secondary winding L2 are balanced to have the same values.

However, if the respective windings of the first transformer T1 have small inductances, then exciting current gets larger, so that the flux derived from a difference in value between respective current of the windings becomes smaller. Consequently, the transformer's effect to balance the respective current deteriorates. If increasing the inductances in order to solve the above problem, then the wire turns of the windings are increased and furthermore, the first transformer T1 becomes easy to be saturated. Then, it is necessary to employ a core with a larger cross-sectional area, causing the transformer to be large-sized.

Therefore, according to the discharge lamp lighter of the second embodiment, a capacitor C51 is connected to the primary winding L1 of the first transformer T1, forming a parallel resonance circuit composed of the inductance of the first reactor L1 and the capacitor C51. Then, it is established that an output of the inverter 2 is in the proximity of a parallel resonance frequency of an inductance by the capacitor C51 and the primary winding L1 of the first transformer T1. FIG. 7 shows an equivalent circuit of the first transformer T1 when the capacitor C51 is connected to the primary winding L1 of the first transformer T1.

In the above-constructed discharge lamp lighter, if the current flowing through the primary winding L1 of the first transformer T1 has the same value as that of the current flowing through the secondary winding L2, the first transformer T1 does not work due to no flux. On the contrary, if there is produced a difference in magnitude between the primary winding L1 and the secondary winding L2 of the first transformer T1, then flux is generated in the first transformer T1 and furthermore, parallel resonance due to the capacitor C51 and an inductance of the primary winding L1 of the first transformer T1 is generated by the flux, so that its impedance is increased to reduce the current flowing through the primary winding L1. Consequently, as the current flowing through the respective windings would be controlled even if the inductance of the first transformer T1 is small, a magnitude of the current flowing through the first discharge lamp 11 becomes equal to that of the current flowing through the second discharge lamp 12, allowing their luminance to be uniformed.

According to the discharge lamp lighter of the second embodiment, as mentioned above, in the structure where the first series circuit 3₁ containing the primary winding L1 of the first transformer T1 and the first discharge lamp 11 and the second series circuit 3₂ containing the secondary winding L2 of the first transformer T1 and the second discharge lamp 12 are connected to the outputs of the inverter 2 generating high-frequency voltage in parallel and where the respective current are balanced by the first transformer T1 in lighting the first discharge lamp 11 and the second discharge lamp 12, the capacitor C51 is connected to the primary winding L1 of the first transformer T1 in parallel to form the parallel resonance circuit. Therefore, it is possible to ensure sufficient impedance without enlarging the inductance of the first transformer T1, due to resonance effect of the parallel resonance circuit. As a result, it is possible to miniaturize the first transformer T1.

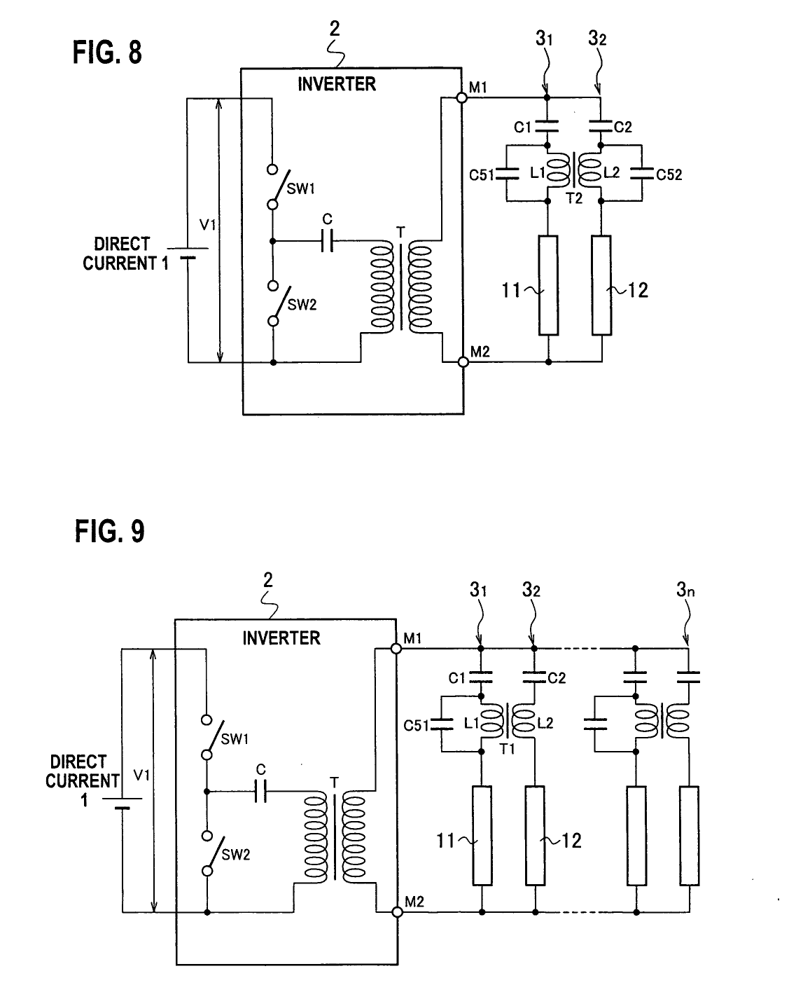

Although the above-mentioned discharge lamp lighter of the second embodiment is constructed in a manner that the capacitor C51 is connected to the primary winding L1 of the first transformer T1 in parallel, the same lamp lighter may be further constructed so that a capacitor C52 is connected to the secondary winding L2 of the first transformer T1 in parallel, as shown in FIG. 8. Then, as the equivalent circuit of the first transformer T1 becomes identical to the equivalent circuit shown in FIG. 7 except for an addition of a capacity of the capacitor C52 to that of the capacitor C51, it is possible to attain the similar operation and effect as those of the above-mentioned discharge lamp lighter of the second embodiment. Further, although it is not shown, the capacitor C52 may be connected to only the secondary winding L2 of the first transformer T1 in parallel. Also in this case, it is possible to attain the similar operation and effect as those of the above-mentioned discharge lamp lighter of the second embodiment.

Although the second embodiment mentioned above is related to a discharge lamp lighter for lighting two discharge lamps, that is, the first discharge lamp 11 and the second discharge lamp 12, objects of the discharge lamp lighter of the present invention is not limited to only two discharge lamps. For instance, as shown in FIG. 9, multiple pairs of series circuits having a similar structure as the pair of the first series circuit 3₁ and the second series circuit 3₂ in pairs may be connected to the outputs of the inverter 2. Also in this case, it is possible to attain the similar operation and effect as those of the above-mentioned discharge lamp lighter of the second embodiment.

### EMBODIMENT 3

The discharge lamp lighter of the third embodiment is provided by combining the discharge lamp lighter of the first embodiment with the discharge lamp lighter of the second embodiment.

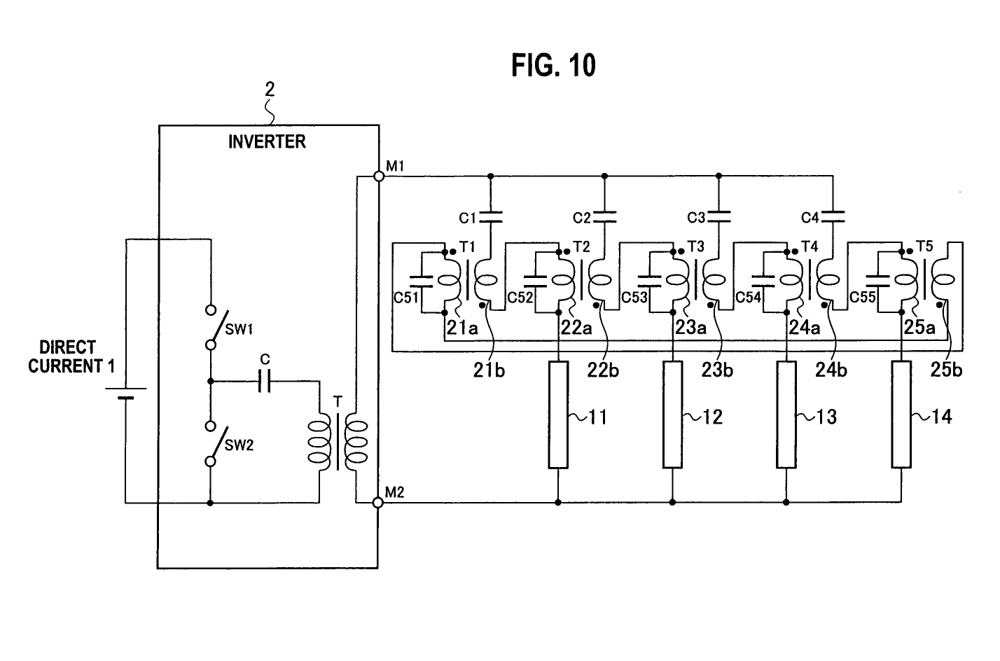

FIG. 10 is a view showing a constitution of the discharge lamp lighter of the third embodiment. In this discharge lamp lighter, the parallel resonant circuit is formed by connecting capacitors C51 to C55 to the primary windings 21a to 25a of the first to fifth transformers T1 to T5 of the discharge lamp lighter of the first embodiment in parallel, respectively.

In the above-constructed discharge lamp lighter, if the current flowing through the primary winding 21a of the first transformer T1 has the same value as that of the current flowing through the secondary winding 21b, the first transformer T1 does not work while generating no flux. On the contrary, if there is produced a difference in magnitude between the primary winding 21a and the secondary winding 21b of the first transformer T1, then flux is generated in the first transformer T1 and furthermore, parallel resonance due to the capacitor C51 and an inductance of the primary winding 21a of the first transformer T1 is generated by the flux, so that its impedance is increased to reduce the current flowing through the primary winding 21a. Consequently, since the current flowing through the respective windings would be controlled even if the inductance of the first transformer T1 is small, a magnitude of the current flowing through the first discharge lamp 11 becomes equal to that of the current flowing through the second discharge lamp 12. Respective circuits connected to the second to fifth transformers T2 to T5 operate as well. Thus, it is possible to uniform respective luminance of all the first to fourth discharge lamps 11 to 14.

According to the discharge lamp lighter of the third embodiment, as mentioned above, since the current flowing through all of the discharge lams are balanced as well as the discharge lamp lighter of the first embodiment, it is possible to do away with a dispersion of the current of the discharge lamps, attaining appropriate lighting characteristics of the lighter.

Again, owing to the formation of the parallel resonant circuit as a result of respectively connecting the capacitors C51 to C55 to the primary windings 21a to 25a of the first to fifth transformers T1 to T5 in parallel, it is possible to ensure sufficient impedance without enlarging the inductance of the first transformer T1, due to resonance effect of the parallel resonance circuit. As a result, it is possible to miniaturize the first to fifth transformers T1 to T5.

### INDUSTRIAL APPLICABILITY

As mentioned above, according to the present invention, current flowing through the first discharge lamp and current flowing through the N^{th.} discharge lamp are balanced by the first transformer and the N+1^{th.} transformer. Regarding the other discharge lamps, current flowing through the n^{th.} discharge lamp and current flowing through the n+1^{th.} discharge lamp are balanced by the n+1^{th.} transformer. Consequently, since the respective current flowing through all of the discharge lamps are balanced, it is possible to do away with a dispersion in the current of the discharge lamps, attaining appropriate lighting characteristics.

Further, according to the present invention, in the transformers for balancing the current flowing through the N pieces of discharge lamps, there is no occurrence of high voltage in a circuit where the windings are connected with each other in parallel. Utilizing that there is no constrain in wiring in the discharge lamp lighter, according to the invention of claim 2, the first to N+1^{th.} transformers are juxtaposed on a high-voltage side of the inverter, while a lighter's portion where a wiring between the first transformer and the N+1^{th.} transformer on both sides of the lighter becomes longer is constructed so that the windings are connected with each other in parallel. Accordingly, it is possible to prevent a reduction in efficiency and destabilization in lighting characteristics, equalizing respective luminance of the discharge lamps. Additionally, since respective wirings of the N pieces of discharge lamps on the low-voltage side can be compiled, it is possible to realize low-cost production, easy-assembling and stabilization in characteristics of the lighter.

Furthermore, according to the present invention, as the n^{th.} ballast element is inserted in a series circuit consisting of the n^{th.} discharge lamp, the primary winding of the n+1^{th.} transformer and the secondary winding of the n^{th.} transformer, in series, it is possible to improve the lighting performance of the lighter furthermore.

Moreover, according to the present invention, in a constitution where the plural series circuits, each of which consists of either the primary winding of the transformer or the secondary winding of the transformer and the discharge lamp, are connected to the outputs of the inverter generating high frequency voltage in parallel, the capacitor is connected to at least either the primary winding or the secondary winding of the transformer in parallel, thereby forming a parallel resonance circuit. Thus, it is possible to ensure sufficient impedance without enlarging the inductance of the first transformer T1, due to resonance effect of the parallel resonance circuit. As a result, it is possible to miniaturize the transformer.

In addition, according to the present invention, it is possible to do away with a dispersion in current of the discharge lamps, accomplishing appropriate lighting characteristics, as similar to the invention of claim 1. In addition, the capacitor is connected to at least either the primary winding or the secondary winding of each of the N+1 pieces of transformers in parallel, forming a parallel resonance circuit. Thus, it is possible to ensure sufficient impedance without enlarging each inductance of the transformers, due to resonance effect of the parallel resonance circuit. As a result, it is possible to miniaturize the N+1 pieces of transformers.

Therefore, the present invention is applicable to a discharge lamp lighter for lighting a plurality of discharge lamps, for example, cold cathode fluorescent lamps, outer electrode fluorescents, fluorescents, etc.

1. A discharge lamp lighter comprising:
an inverter for converting direct voltage into high frequency voltage;
N (N: a positive integer) pieces of discharge lamps; and
N+1 pieces of transformers, wherein:
an n^{th.} discharge lamp (n=1, 2, . . . , N), a primary winding of an n+1^{th.} transformer and a secondary winding of the n^{th.} transformer are connected in series between output terminals of the inverter, and
a primary winding of a first transformer is connected to a secondary winding of the n+1^{th.} transformer in series.

2. The discharge lamp lighter of claim 1, wherein
the secondary winding of the n^{th.} transformer and a primary winding of the n+1 ^{th.} transformer are connected to each other between the output terminal on a high-voltage side of the inverter and one end of the n^{th.} discharge lamp, while another end of the n^{th.} discharge lamp is connected to the outer terminal on a low-voltage side of the inverter.

3. The discharge lamp lighter of claim 1, wherein
an n^{th.} ballast element is inserted in a series circuit consisting of the n^{th.} discharge lamp, the primary winding of the n+1^{th.} transformer and the secondary winding of the n^{th.} transformer, in series.

4. The discharge lamp lighter of claim 3, wherein
the n^{th.} ballast element, the secondary winding of the n^{th.} transformer and the primary winding of the n+1^{th.} transformer are connected to each other between the output terminal on a high-voltage side of the inverter and one end of the n^{th.} discharge lamp, while another end of the n^{th.} discharge lamp is connected to the outer terminal on a low-voltage side of the inverter.

5. A discharge lamp lighter having an inverter for converting direct voltage into high frequency voltage and a plurality of series circuits connected to outputs of the inverter in parallel, each of the series circuits consisting of either a primary winding of a transformer or a secondary winding of the transformer and a discharge lamp, wherein:
a capacitor is connected to at least either the primary winding or the secondary winding of the transformer, in parallel.

6. The discharge lamp lighter of claim 1, wherein
a capacitor is connected to at least either a primary winding or a secondary winding of each of the N+1 pieces of transformers, in parallel.

7. The discharge lamp lighter of claim 2, wherein
a capacitor is connected to at least either a primary winding or a secondary winding of each of the N+1 pieces of transformers, in parallel.

8. The discharge lamp lighter of claim 3, wherein
a capacitor is connected to at least either a primary winding or a secondary winding of each of the N+1 pieces of transformers, in parallel.

9. The discharge lamp lighter of claim 4, wherein
a capacitor is connected to at least either a primary winding or a secondary winding of each of the N+1 pieces of transformers, in parallel.
